(19) United States
(12) Patent Application Publication
(10) Pub. No.: US 2026/0081434 A1
(43) Pub. Date: Mar. 19, 2026

(54) STORAGE BATTERY CONTROL DEVICE, ELECTRICITY STORAGE SYSTEM, AND STORAGE BATTERY CONTROL METHOD

(71) Applicant: YAZAKI CORPORATION, Tokyo (JP)

(72) Inventor: Takahiro Syouda, Susono-shi (JP)

(21) Appl. No.: 19/402,685

(22) Filed: Nov. 26, 2025

Related U.S. Application Data
(63) Continuation of application No. PCT/JP2024/019365, filed on May 27, 2024.

(30) Foreign Application Priority Data
Jun. 27, 2023 (JP) 2023-105014

(51) Int. Cl. H02J 7/35; H02J 3/32; H02J 3/46; H02J 7/00

(52) U.S. Cl. CPC H02J 7/35; H02J 3/32; H02J 3/466; H02J 7/865; H02J 2207/20

(57) ABSTRACT

An electricity storage system controller executes a charge and discharge mode in which a part of the plurality of electricity storage strings is in a discharge state and the electricity storage strings other than the part are in a charge standby state, or a part of the plurality of electricity storage strings is in a charge state and the electricity storage strings other than the part are in a discharge standby state, and determines a ratio of the electricity storage strings in the discharge state to the electricity storage strings in the charge standby state or a ratio of the electricity storage strings in the charge state to the electricity storage strings in the discharge standby state, based on transition prediction information in which transitions of generated power of a solar power generation device and consumption power of a load connected to a power reception point are predicted.

### CROSS-REFERENCE TO RELATED APPLICATIONS

This is a continuation of International Application No. PCT/JP2024/019365 filed on May 27, 2024, and claims priority from Japanese Patent Application No. 2023-105014 filed on Jun. 27, 2023, the entire content of which is incorporated herein by reference.

### TECHNICAL FIELD

The present invention relates to a storage battery control device, an electricity storage system, and a storage battery control method.

### BACKGROUND ART

As an electricity storage system using solar generation power, an electricity storage system is known in which a plurality of storage batteries are provided, and each storage battery performs charging and discharging independently of each other by switching on and off a switch (for example, see Patent Literature 1). In the electricity storage system disclosed in Patent Literature 1, when charging of any of the storage batteries is stopped by turning off a corresponding switch, another storage battery is in a state of discharging to a load or a state of being able to discharge to a load.

### CITATION LIST

### Patent Literature

Patent Literature 1: JP2012-44733A

### SUMMARY OF INVENTION

In the electricity storage system disclosed in Patent Literature 1, a ratio between a storage battery to be charged and a storage battery to be discharged or prepared for discharging is not considered. Therefore, depending on the balance between the solar generation power and the load consumption power, it is conceivable that excess or deficiency occurs in the charge and discharge power.

The present invention has been made in view of the above circumstances, and an object thereof is to provide a storage battery control device, an electricity storage system, and a storage battery control method capable of smoothly switching between charge and discharge in an electricity storage system using generated power and optimizing charge and discharge power according to a balance between the generated power and load consumption power.

An storage battery control device according to the present invention is a storage battery control device for controlling, in a power system including an electricity storage system that includes a plurality of bidirectional power converters connected in parallel to a power reception point of a power grid and a plurality of storage batteries connected to the power converters, respectively, and a power generation device connected to the power reception point, charge and discharge of the electricity storage system, in which a charge and discharge mode is executed in which a part of the plurality of storage batteries are in a discharge state and the storage batteries other than this part are in a charge standby state, or a part of the plurality of storage batteries are in a charge state and the storage batteries other than this part are in a discharge standby state, and based on transition prediction information in which transitions of generated power of the power generation device and consumption power of a load connected to the power reception point, or transitions of discharge power and charge power of the electricity storage system are predicted, a ratio of the storage batteries in the discharge state to the storage batteries in the charge standby state, or a ratio of the storage batteries in the charge state to the storage batteries in the discharge standby state, is determined.

An electricity storage system according to the present invention is an electricity storage system provided in a power system in which a power generation device is connected to a power reception point of a power grid, and the electricity storage system includes: a plurality of bidirectional power converters connected in parallel to the power reception point; a plurality of storage batteries connected to the power converters, respectively; and an storage battery control device configured to control charge and discharge of the plurality of storage batteries, in which the storage battery control device executes a charge and discharge mode in which a part of the plurality of storage batteries are in a discharge state and the storage batteries other than this part are in a charge standby state, or a part of the plurality of storage batteries are in a charge state and the storage batteries other than this part are in a discharge standby state, and determines a ratio of the storage batteries in the discharge state to the storage batteries in the charge standby state, or a ratio of the storage batteries in the charge state to the storage batteries in the discharge standby state, based on transition prediction information in which transitions of generated power of the power generation device and consumption power of a load connected to the power reception point, or transitions of discharge power and charge power of the electricity storage system are predicted.

A storage battery control method according to the present invention is a storage battery control method executed by using a storage battery control device configured to control, in a power system including an electricity storage system that includes a plurality of bidirectional power converters connected in parallel to a power reception point of a power grid and a plurality of storage batteries connected to the power converters, respectively, and a power generation device connected to the power reception point, charge and discharge of the electricity storage system, in which a charge and discharge mode is executed in which a part of the plurality of storage batteries are in a discharge state and the storage batteries other than this part are in a charge standby state, or a part of the plurality of storage batteries are in a charge state and the storage batteries other than this part are in a discharge standby state, and based on transition prediction information in which transitions of generated power of the power generation device and consumption power of a load connected to the power reception point, or transitions of discharge power and charge power of the electricity storage system are predicted, a ratio of the storage batteries in the discharge state to the storage batteries in the charge standby state, or a ratio of the storage batteries in the charge state to the storage batteries in the discharge standby state, is determined.

According to the present invention, in an electricity storage system using generated power, switching between charge and discharge can be smoothly performed, and charge and discharge power can be optimized according to the balance between the generated power and load consumption power.

### BRIEF DESCRIPTION OF DRAWINGS

FIG. 1 is a diagram schematically illustrating an electricity storage system including an electricity storage system controller and a PV-electricity storage system according to one embodiment of the present invention;

FIG. 2 is a diagram illustrating a definition of positive and negative of power under a power reception point of the PV-electricity storage system;

FIG. 3 is a diagram illustrating a relationship between solar generation power and load consumption power for each time zone on a sunny day;

FIG. 4 is a diagram illustrating a relationship between the solar generation power and the load consumption power for each time zone on a certain day with moving clouds;

FIG. 5 is a diagram illustrating a flow of power during execution of a discharge mode in the PV-electricity storage system;

FIG. 6 is a diagram illustrating a flow of power during execution of a charge mode in the PV-electricity storage system;

FIG. 7 is a diagram illustrating a flow of power during discharge when a charge and discharge mode in the PV-electricity storage system is executed;

FIG. 8 is a diagram illustrating a flow of power during charge when the charge and discharge mode in the PV-electricity storage system is executed;

FIG. 9 is a flowchart illustrating processing of the electricity storage system controller;

FIG. 10 is a diagram illustrating a threshold when the electricity storage system controller determines whether power is being purchased or sold, and a reference level when the electricity storage system controller controls purchased power and sold power;

FIG. 11 is a flowchart illustrating processing of the electricity storage system controller; and

FIG. 12 is a flowchart illustrating processing of the electricity storage system controller.

### DESCRIPTION OF EMBODIMENTS

Hereinafter, the present invention will be described with reference to a preferred embodiment. The present invention is not limited to the embodiment to be described below, and the embodiment can be appropriately modified without departing from the gist of the present invention. In the embodiment to be described below, a part of configurations may be not described or shown in the drawings, and regarding details of the omitted techniques, publicly known or well-known techniques will be appropriately applied as long as there is no contradiction with the contents to be described below.

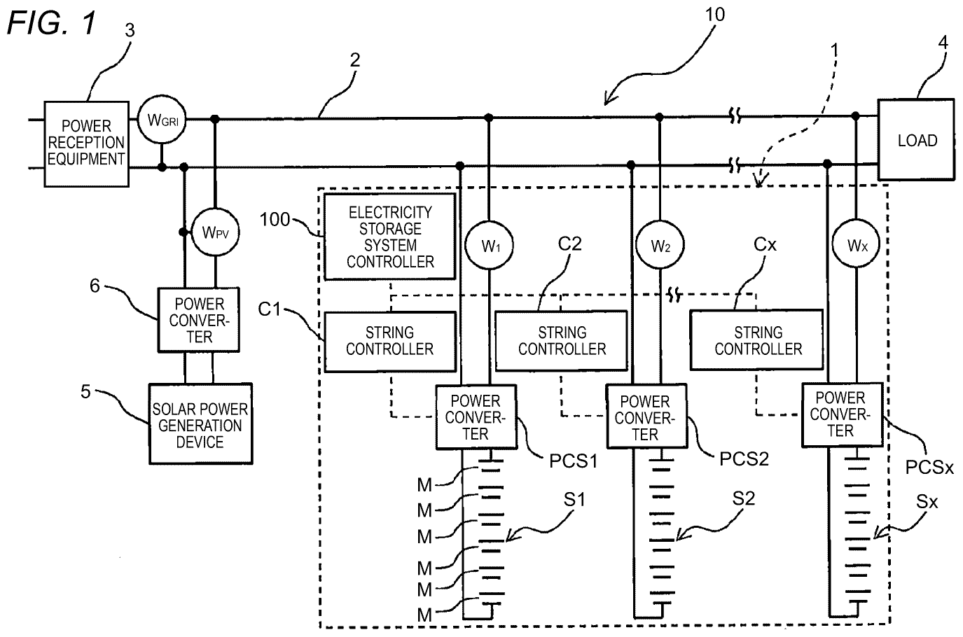

FIG. 1 is a diagram schematically illustrating an electricity storage system 1 including an electricity storage system controller 100 and a photovoltaic (PV)-electricity storage system according to one embodiment of the present invention. As illustrated in the drawing, the electricity storage system 1 includes x (x is an integer of 2 or more) electricity storage strings S1 to Sx, x power converters PCS1 to PCSx, x power meters W₁ to W_{X}, x string controllers C1 to Cx, and the electricity storage system controller 100. Each of the power converters PCS1 to PCSx is provided corresponding to each of the electricity storage strings S1 to Sx, and each of the electricity storage strings S1 to Sx is connected to a string bus 2 via each of the power converters PCS1 to PCSx. The plurality of electricity storage strings S1 to Sx are connected in parallel to the string bus 2.

The string bus 2 connects a power reception equipment 3 and a load 4, and supplies power from the power reception equipment 3 to the load 4. The string bus 2 connects a solar power generation device 5 and the load 4 via a power converter 6, and supplies power from the solar power generation device 5 to the load 4. The string bus 2 connects the plurality of electricity storage strings S1 to Sx and the load 4, and supplies power from the plurality of electricity storage strings S1 to Sx to the load 4. The string bus 2 connects the solar power generation device 5 and the plurality of electricity storage strings S1 to Sx, and supplies power from the solar power generation device 5 to the plurality of electricity storage strings S1 to Sx. The string bus 2 connects the solar power generation device 5 and the power reception equipment 3, and supplies power from the solar power generation device 5 to the power reception equipment 3. The string bus 2 connects the plurality of electricity storage strings S1 to Sx and the power reception equipment 3, and supplies power from the plurality of electricity storage strings S1 to Sx to the power reception equipment 3.

Each of the electricity storage strings S1 to Sx is a stationary power supply including a plurality of storage battery modules M connected in series. Although not particularly limited, the electricity storage strings S1 to Sx according to the present embodiment are obtained by recycling used storage batteries, and the storage battery modules M differ in a degree of deterioration. The storage battery module M is a secondary battery such as a lithium ion battery or a lithium ion capacitor. The storage battery module M is charged by being supplied with power from the power reception equipment 3 and the solar power generation device 5 through the string bus 2. On the other hand, the storage battery module M discharges to the load 4 and the power reception equipment 3 through the string bus 2.

The electricity storage strings S1 to Sx may include a plurality of storage battery cells or storage battery packs connected in series, instead of the plurality of storage battery modules M connected in series.

Each of the power converters PCS1 to PCSx is a bidirectional AC/DC converter, converts an alternating current input from the string bus 2 into a direct current and outputs the direct current to each of the electricity storage strings S1 to Sx, and converts a direct current input from each of the electricity storage strings S1 to Sx into an alternating current and outputs the alternating current to the string bus 2.

The power converter 6 is provided between the solar power generation device 5 and the string bus 2. The power converter 6 is a DC/AC converter, and converts a direct current output from the solar power generation device 5 into an alternating current and outputs the alternating current to the string bus 2. That is, the PV-electricity storage system 10 according to the present embodiment is of an AC link type. A type of the PV-electricity storage system 10 may be a DC link type.

Each of the power meters W₁ to W_{X} measures input and output power of each of the electricity storage strings S1 to Sx and transmits the input and output power to the electricity storage system controller 100. The string bus 2 is provided with a power meter W_{GRI}. The power meter W_{GRI} measures input and output power of the power reception equipment 3 and transmits the input and output power to the electricity storage system controller 100. A power meter W_{PV} measures output power of the solar power generation device 5 and transmits the output power to the electricity storage system controller 100.

The electricity storage system controller 100 executes a discharge mode, a charge mode, and a charge and discharge mode to be described later, based on the power measured by the power meters W₁ to W_{X}, W_{GRI}, and W_{PV} and transition prediction information in which transitions of solar generation power and load consumption power are predicted. The electricity storage system controller 100 transmits, to each of the string controllers C1 to Cx, an instruction value for determining a charge and discharge amount of each of the electricity storage strings S1 to Sx, such as a charge and discharge power instruction value or a charge and discharge current instruction value. Each of the string controllers C1 to Cx controls each of the power converters PCS1 to PCSx according to the instruction value.

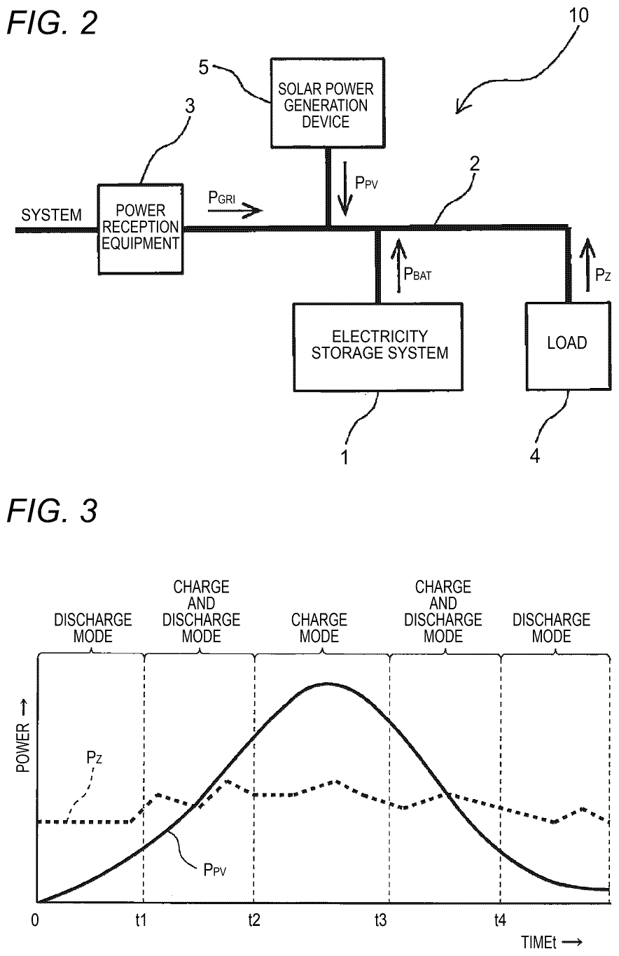

FIG. 2 is a diagram illustrating a definition of positive and negative of power under a power reception point of the PV-electricity storage system 10. As illustrated in this figure, a direction of a current flowing toward the power reception point is defined as a positive direction. Therefore, output power of the electricity storage system 1 (hereinafter, referred to as electricity storage system power) P_{BAT} indicates a positive value, and the electricity storage system power P_{BAT} indicating a negative value is input power of each of the electricity storage strings S1 to Sx. Output power (hereinafter, referred to as purchased power) P_{GRI} of the power reception equipment 3 indicates a positive value, and the purchased power P_{GRI} indicating a negative value is input power (that is, sold power) of the power reception equipment 3. The output power of the solar power generation device 5 (hereinafter, referred to as solar generation power) P_{PV} indicates a positive value. The input power of the load 4 (hereinafter, referred to as load consumption power) P_{Z} indicates a negative value.

A relationship of power under the power reception point is expressed by the following formula (1).

$$[ Math . 1 ]$$

$$0 = {P}_{Z} + {P}_{PV} + {P}_{BAT} + {P}_{GRI} \qquad ( 1 )$$

Therefore, the electricity storage system power P_{BAT} is expressed by the following formula (2), and the load consumption power P_{Z} is expressed by the following formula (3).

$$[ Math . 2 ]$$

$${P}_{BAT} = - {P}_{Z} - {P}_{PV} - {P}_{GRI} \qquad ( 2 )$$

$$[ Math . 3 ]$$

$${P}_{Z} = - {P}_{PPV} - {P}_{BAT} - {P}_{GRI} \qquad ( 3 )$$

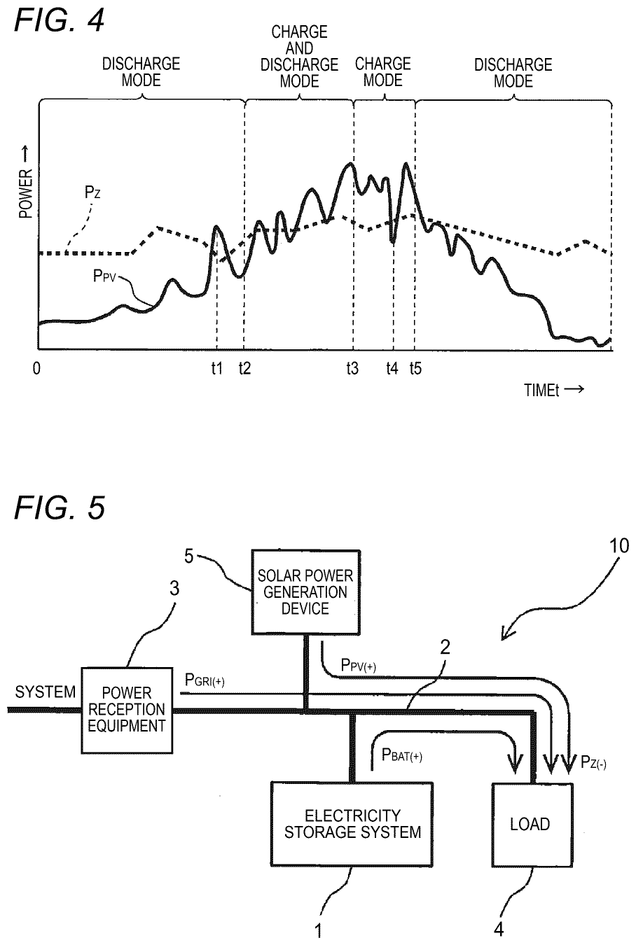

FIG. 3 is a diagram illustrating a relationship between the solar generation power P_{PV} and the load consumption power P_{Z} for each time zone on a sunny day. FIG. 4 is a diagram illustrating a relationship between the solar generation power P_{PV} and the load consumption power P_{Z} for each time zone on a certain day with moving clouds.

As illustrated in FIG. 3, on the sunny day, in general, the solar generation power P_{PV} gradually increases from a minimum value to a maximum value (from time 0 to time t2 and t3), and then gradually decreases to the minimum value (from time t2 and t3 to time t4 and thereafter). That is, in general, on a sunny day, the solar generation power P_{PV} transitions stably. In contrast, the load consumption power P_{Z} does not vary greatly in units of days, but varies slightly in units of time. Therefore, on the sunny day, in general, after a time period (from time 0 to times t1 and t2) in which the solar generation power P_{PV} falls below the load consumption power P_{Z} continues, a time period (from times t1 and t2 to times t3 and t4) in which the solar generation power P_{PV} exceeds the load consumption power P_{Z} continues, and thereafter, a time period (from times t3 and t4 to time t4 and thereafter) in which the solar generation power P_{PV} falls below the load consumption power P_{Z} again continues.

In a time zone in which the solar generation power P_{PV} falls below the load consumption power P_{Z}, since the solar generation power P_{PV} cannot cover the load consumption power P_{Z}, the discharge mode in which the electricity storage system power P_{BAT} is used for the load consumption power P_{Z} is executed. In the discharge mode, when the solar generation power P_{PV} and the electricity storage system power P_{BAT} cannot cover the load consumption power P_{Z}, the purchased power P_{GRI} is used for the load consumption power P_{Z}.

In a time zone in which the solar generation power P_{PV} exceeds the load consumption power P_{Z}, since the solar generation power P_{PV} becomes surplus, the charge mode in which the surplus solar generation power P_{PV} is used as charge power (−P_{BAT}) of the electricity storage system 1 is executed. In the charge mode, when the surplus solar generation power P_{PV} exceeds a charge capacity of the electricity storage system 1, a part of the surplus solar generation power P_{PV} is used as the sold power (−P_{GRI}), or an output control of the solar power generation device is performed.

Here, the discharge mode is a mode executed in a time zone in which the solar generation power P_{PV} is sufficiently small relative to the load consumption power P_{Z}, and the charge mode is a mode executed in a time zone in which the solar generation power P_{PV} is sufficiently large relative to the load consumption power P_{Z}. In contrast, in a time zone in which a difference between the solar generation power P_{PV} and the load consumption power P_{Z} is not sufficient and a magnitude relationship between the solar generation power P_{PV} and the load consumption power P/may be reversed, the charge and discharge mode is executed. At the time of discharge when executing the charge and discharge mode, a part of the plurality of electricity storage strings S1 to Sx is in a discharging state (hereinafter, referred to as a discharge state), and the electricity storage strings S1 to Sx other than the part are in a standby state for charging (hereinafter, referred to as a charge standby state). At the time of charge when executing the charge and discharge mode, a part of the plurality of electricity storage strings S1 to Sx is in a charging state (hereinafter, referred to as a charge state), and the electricity storage strings S1 to Sx other than the part are in a standby state for discharging (hereinafter, referred to as a discharge standby state). Here, the charge standby state is a concept including not only a state in which the electricity storage system power P_{BAT} is 0 but also a state (a discharge state) in which the electricity storage system power P_{BAT} is a positive value. That is, the electricity storage strings S1 to Sx in the charge standby state are set to a bypass state (capable of charging more power) optimum for charge, but may be discharged as much as possible when the electricity storage system 1 is requested to discharge. The discharge standby state is a concept including not only a state in which the electricity storage system power P_{BAT} is 0 but also a state (a charge state) in which the electricity storage system power P_{BAT} is a negative value. That is, the electricity storage strings S1 to Sx in the discharge standby state are set to a bypass state (capable of discharging more power) optimum for discharge, but may be charged as much as possible when the electricity storage system 1 is requested to charge.

As illustrated in FIG. 4, on a certain day with moving clouds, in general, the solar generation power P_{PV} increases from a minimum value to a maximum value (from time 0 to time t3) in units of days, and then decreases to the minimum value (from time t3 to time t5 and thereafter). However, the solar generation power P_{PV} transitions unstably due to an influence of the moving clouds. Therefore, on a day with moving clouds, in general, after a time period (from time 0 to time t1) in which the solar generation power P_{PV} falls below the load consumption power P_{Z} continues, a time period (from time t1 to time t5) in which a reversal of the magnitude relationship between the solar generation power P_{PV} and the load consumption power P_{Z} is repeated continues, and then a time period (time t5 and thereafter) in which the solar generation power P_{PV} falls below the load consumption power P_{Z} again continues.

The time zone (from time 0 to time t1, and time t5 and thereafter) in which the solar generation power P_{PV} falls below the load consumption power P_{Z} is longer on a certain day with moving clouds than on a sunny day. Therefore, a time zone in which the discharge mode is executed is longer on a certain day with moving clouds than on a sunny day. A time zone (from time t1 to time t5) in which the reversal of the magnitude relationship between the solar generation power P_{PV} and the load consumption power P_{Z} is repeated continues for a longer time on a certain day with moving clouds. Therefore, a time zone in which the charge and discharge mode is executed is longer on a certain day with moving clouds than on a sunny day.

The electricity storage system controller 100 determines any one mode of the discharge mode, the charge mode, and the charge and discharge mode according to the magnitude relationship between the solar generation power P_{PV} and the load consumption power P_{Z}. When the solar generation power P_{PV} falls below the load consumption power P_{Z} and a difference therebetween is predicted to be equal to or larger than a predetermined value, the electricity storage system controller 100 determines the discharge mode. When the solar generation power P_{PV} exceeds the load consumption power P_{Z} and the difference therebetween is predicted to be equal to or larger than a predetermined value, the electricity storage system controller 100 determines the charge mode. When the difference between the solar generation power P_{PV} and the load consumption power P_{Z} is predicted to be less than a predetermined value, the electricity storage system controller 100 determines the charge and discharge mode.

The magnitude relationship between the solar generation power P_{PV} and the load consumption power P_{Z} may be predicted based on a current value, may be predicted based on an average value obtained by moving-averaging the current value and a past value, or may be predicted based on a weather forecast.

FIG. 5 is a diagram illustrating a flow of power when the discharge mode in the PV-electricity storage system 10 is executed. As illustrated in this figure, when the discharge mode is executed, the solar generation power P_{PV} is supplied from the solar power generation device to the load 4, and the electricity storage system power P_{BAT} is supplied from the electricity storage system 1 to the load 4. When the solar generation power P_{PV} and the electricity storage system power P_{BAT} cannot cover the load consumption power P_{Z}, the purchased power P_{GRI} is supplied from the power reception equipment 3 to the load 4.

When the discharge mode is executed, the electricity storage system controller 100 adjusts the electricity storage system power P_{BAT} (discharge power) such that the purchased power P_{GRI} measured by the power meter W_{GRI} is as small as possible. When the discharge mode is executed, when the solar generation power P_{PV} exceeds the load consumption power P_{Z} (time t1 in FIG. 4), the electricity storage system controller 100 supplies the surplus solar generation power P_{PV} to the system as the sold power (−P_{GRI}) or reduces the output of the solar power generation device 5.

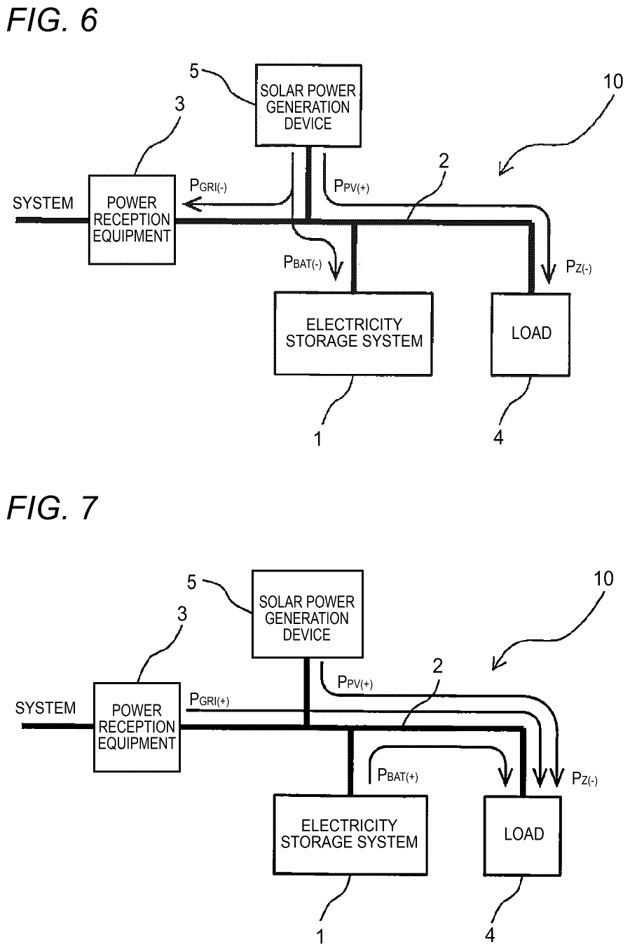

FIG. 6 is a diagram illustrating a flow of power when the charge mode in the PV-electricity storage system 10 is executed. As illustrated in this figure, when the charge mode is executed, the solar generation power P_{PV} is supplied from the solar power generation device 5 to the load 4 and the electricity storage system 1. When the charge capacity of the electricity storage system 1 is not sufficient, a part of the solar generation power P_{PV} is supplied from the solar power generation device 5 to the power reception equipment 3 as the sold power (−P_{GRI}).

When the charge mode is executed, the electricity storage system controller 100 adjusts the electricity storage system power (−P_{BAT} (charge power) such that the sold power (−P_{GRI}) measured by the power meter W_{GRI} is as small as possible. When the charge mode is executed, when the solar generation power P_{PV} falls below the load consumption power P_{Z} (time t4 in FIG. 4), the electricity storage system controller 100 supplies the purchased power P_{GRI} from the system to the load 4.

The electricity storage system controller 100 compares the predicted solar generation power P_{PV} and the predicted load consumption power P_{Z} included in transition prediction information in which transitions of the solar generation power P_{PV} and the load consumption power P_{Z} are predicted, and determines, according to a comparison result, a ratio between a sum of charge power limit values of the electricity storage strings S1 to Sx in the charge mode and a sum of discharge power limit values of the electricity storage strings S1 to Sx in the discharge mode. The ratio is determined as, for example, a ratio between an average value of the predicted solar generation power P_{PV} and an average value of the load consumption power P_{Z}. In this case, when the average value of the predicted solar generation power P_{PV} is equal to the average value of the predicted load consumption power P_{Z}, the ratio is determined to be 1:1. The less the average value of the predicted solar generation power P_{PV} is relative to the average value of the predicted load consumption power P_{Z}, the ratio is determined such that a proportion occupied by the electricity storage strings S1 to Sx in the discharge state is larger. The average value may be replaced with the maximum value.

FIG. 7 is a diagram illustrating a flow of power during discharge when the charge and discharge mode is executed in the PV-electricity storage system 10. As illustrated in this figure, during discharge when the charge and discharge mode is executed, the solar generation power P_{PV} is supplied from the solar power generation device 5 to the load 4, and the electricity storage system power P_{BAT} is supplied from the electricity storage system 1 to the load 4. When the solar generation power P_{PV} and the electricity storage system power P_{BAT} cannot cover the load consumption power P_{Z}, the purchased power (+P_{GRI}) is supplied from the power reception equipment 3 to the load 4. Here, during discharge when the charge and discharge mode is executed, in the electricity storage system 1, a part of the electricity storage strings S1 to Sx is in the discharge state, and the electricity storage strings S1 to Sx other than this part are in the charge standby state.

During discharge when the charge and discharge mode is executed, the electricity storage system controller 100 adjusts the electricity storage system power P_{BAT} (discharge power) such that the purchased power P_{GRI} measured by the power meter W_{GRI} is as small as possible. At a time of a transition from the discharge mode to the charge and discharge mode, the electricity storage system controller 100 determines a ratio (hereinafter, referred to as a discharge/charge standby ratio) between the electricity storage strings S1 to Sx in the discharge state and the electricity storage strings S1 to Sx in the charge standby state, and determines whether each of the electricity storage strings S1 to Sx is in the discharge state or in the charge standby state. At this time, the electricity storage system controller 100 determines the discharge/standby state ratio and the state (the discharge state or the charge standby state) of each of the electricity storage strings S1 to Sx, based on the transition prediction information in which the transitions of the solar generation power P_{PV} and the load consumption power P_{Z} are predicted and information about the discharge power limit values and the charge power limit values of the electricity storage strings S1 to Sx. The discharge current limit value may be used instead of the discharge power limit value, and the charge current limit value may be used instead of the charge power limit value.

The electricity storage system controller 100 receives, from a host system (not illustrated), information (information on the past solar generation power P_{PV} and the past load consumption power P_{Z}, weather forecast, and the like) referred to when predicting the transitions of the solar generation power P_{PV} and the load consumption power P_{Z}. The electricity storage system controller 100 refers to the information received from the host system, and predicts the transitions of the solar generation power P_{PV} and the load consumption power P_{Z} after the present time based on, for example, changes in the latest one hour, a situation in the same time zone in the past, the weather, and the like. It is not essential for the electricity storage system controller 100 to predict the transitions of the solar generation power P_{PV} and the load consumption power P_{Z}. The host system may predict the transitions of the solar generation power P_{PV} and the load consumption power P_{Z} and transmit the predicted transitions to the electricity storage system controller 100.

The electricity storage system controller 100 compares the predicted solar generation power P_{PV} with the predicted load consumption power P_{Z} included in the transition prediction information when the charge and discharge mode is executed, and determines the discharge/charge standby ratio according to the comparison result. The discharge/charge standby ratio is determined to be, for example, the ratio between an average value of the predicted solar generation power P_{PV} and an average value of the predicted load consumption power P_{Z}. In this case, when the average value of the predicted solar generation power P_{PV} is equal to the average value of the predicted load consumption power P_{Z}, the discharge/charge standby ratio is determined to be 1:1. The less the average value of the predicted solar generation power P_{PV} is relative to the average value of the predicted load consumption power P_{Z}, the discharge/charge standby ratio is determined such that a proportion occupied by the electricity storage strings S1 to Sx in the discharge state becomes larger. The average value may be replaced with the maximum value.

The discharge/charge standby ratio is determined, for example, as a ratio of an average value of a difference (P_{Z}−P_{PV}) when the predicted solar generation power P_{PV} falls below the predicted load consumption power P_{Z} to an average value of a difference (P_{PV}−P_{Z}) when the predicted solar generation power P_{PV} exceeds the predicted load consumption power P_{Z}. In this case, when the average value of the difference (P_{Z}−P_{PV}) when the predicted solar generation power P_{PV} falls below the predicted load consumption power P_{Z} is equal to the average value of the difference (P_{PV}−P_{Z}) when the predicted solar generation power P_{PV} exceeds the predicted load consumption power P_{Z}, the discharge/charge standby ratio is 1:1. The larger the average value of the difference (P_{Z}−P_{PV}) when the predicted solar generation power P_{PV} falls below the predicted load consumption power P_{Z} is relative to the average value of the difference (P_{PV}−P_{Z}) when the predicted solar generation power P_{PV} exceeds the predicted load consumption power P_{Z}, the discharge/charge standby ratio is determined such that the ratio occupied by the electricity storage strings S1 to Sx in the discharge state becomes lager. The average value may be replaced with the maximum value.

The string controllers C1 to Cx of the electricity storage strings S1 to Sx calculate the discharge power limit values and the charge power limit values of the electricity storage strings S1 to Sx based on a state of charge (SOC), a state of health (SOH), and the like of the storage battery module M, and transmit the calculated values to the electricity storage system controller 100. The electricity storage system controller 100 determines whether the electricity storage strings S1 to Sx is in the discharge state or the charge standby state based on the discharge power limit values and the charge power limit values received from the string controllers C1 to Cx. For example, the electricity storage system controller 100 determines whether the electricity storage strings S1 to Sx is in the discharge state or the charge standby state such that a ratio of a sum value of the discharge power limit values of the electricity storage strings S1 to Sx in the discharge state to a sum value of the charge power limit values of the electricity storage strings S1 to Sx in the charge standby state approaches the discharge/charge standby ratio as much as possible.

Here, during discharge when the charge and discharge mode is executed, the load consumption power P_{Z} may fall below the solar generation power P_{PV}. In this case, the electricity storage system controller 100 decreases the electricity storage system power P_{BAT} of the electricity storage strings S1 to Sx in the discharge state from a positive value to 0, and decreases the electricity storage system power P_{BAT} of the electricity storage strings S1 to Sx in the charge standby state from 0 to a negative value. It is not essential to maintain the electricity storage system power P_{BAT} of the electricity storage strings S1 to Sx in the charge standby state at 0 during discharge when the charge and discharge mode is executed. During discharge when the charge and discharge mode is executed, the electricity storage system power P_{BAT} of the electricity storage strings S1 to Sx in the charge standby state may be a positive value to discharge the electricity storage strings S1 to Sx in the charge standby state.

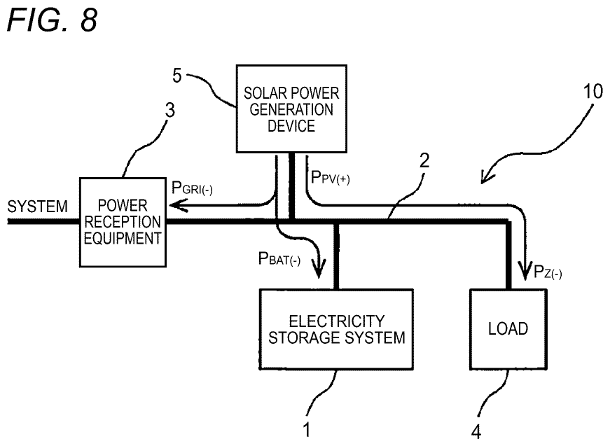

FIG. 8 is a diagram illustrating a flow of power during charge when the charge and discharge mode is executed in the PV-electricity storage system 10. As illustrated in this figure, during charge when the charge and discharge mode is executed, the solar generation power P_{PV} is supplied from the solar power generation device 5 to the load 4 and the electricity storage system 1. When the charge capacity of the electricity storage system 1 is not sufficient, a part of the solar generation power P_{PV} is supplied from the solar power generation device 5 to the power reception equipment 3 as the sold power (−P_{GRI}). Here, during charge when the charge and discharge mode is executed, in the electricity storage system 1, a part of the electricity storage strings S1 to Sx is in the charge state, and the electricity storage strings S1 to Sx other than this part are in the discharge standby state.

During charge when the charge and discharge mode is executed, the electricity storage system controller 100 adjusts the electricity storage system power (−P_{BAT}, charge power) such that the sold power (−P_{GRI}) measured by the power meter W_{GRI} is as small as possible. At a time of a transition from the charge mode to the charge and discharge mode, the electricity storage system controller 100 determines a ratio (hereinafter, referred to as a charge/discharge standby ratio) between the electricity storage strings S1 to Sx in the charge state and the electricity storage strings S1 to Sx in the discharge standby state, and determines whether each of the electricity storage strings S1 to Sx is in the charge state or in the discharge standby state. At this time, the electricity storage system controller 100 determines the charge/discharge standby ratio and the state of each of the electricity storage strings S1 to Sx, based on the transition prediction information in which the transitions of the solar generation power P_{PV} and the load consumption power P_{Z} are predicted and the information on charge power limit values and discharge power limit values of the electricity storage strings S1 to Sx. A charge current limit value may be used instead of the charge power limit value, and a discharge current limit value may be used instead of the discharge power limit value.

Similarly to the transition from the discharge mode to the charge and discharge mode, the electricity storage system controller 100 predicts the transitions of the solar generation power P_{PV} and the load consumption power P_{Z} with reference to information received from a host system. The electricity storage system controller 100 compares the predicted solar generation power P_{PV} with the predicted load consumption power P_{Z} included in the transition prediction information when the charge and discharge mode is executed, and determines the charge/discharge standby ratio according to the comparison result.

The charge/discharge standby ratio is determined to be, for example, the ratio between an average value of the predicted solar generation power P_{PV} and an average value of the predicted load consumption power P_{Z}. In this case, when the average value of the predicted solar generation power P_{PV} is equal to the average value of the predicted load consumption power P_{Z}, the charge/discharge standby ratio is determined to be 1:1. The larger the average value of the predicted solar generation power P_{PV} is relative to the average value of the predicted load consumption power P_{Z}, the larger the charge/discharge standby ratio is determined such that a proportion occupied by the electricity storage strings S1 to Sx in the charge state becomes. The average value may be replaced with the maximum value.

The charge/discharge standby ratio is determined, for example, as a ratio of the average value of the difference (P_{PV}−P_{Z}) when the predicted solar generation power P_{PV} exceeds the predicted load consumption power P_{Z} to the average value of the difference (P_{Z}−P_{PV}) when the predicted solar generation power P_{PV} falls below the predicted load consumption power P_{Z}. In this case, when the average value of the difference (P_{PV}−P_{Z}) when the predicted solar generation power P_{PV} exceeds the predicted load consumption power P_{Z} is equal to the average value of the difference (P_{Z}−P_{PV}) when the predicted solar generation power P_{PV} falls below the predicted load consumption power P_{Z}, the charge/discharge standby ratio is 1:1. The larger the average value of the difference (P_{PV}−P_{Z}) when the predicted solar generation power P_{PV} exceeds the predicted load consumption power P_{Z} is relative to the average value of the difference (P_{Z}−P_{PV}) when the predicted solar generation power P_{PV} falls below the predicted load consumption power P_{Z}, the larger the charge/discharge standby ratio is determined such that the proportion occupied by the electricity storage strings S1 to Sx in the charge state becomes. The average value may be replaced with the maximum value.

The electricity storage system controller 100 determines whether the electricity storage strings S1 to Sx is in the charge state or the discharge standby state based on the charge power limit values and the discharge power limit values of the electricity storage strings S1 to Sx received from the string controllers C1 to Cx. For example, the electricity storage system controller 100 determines whether the electricity storage strings S1 to Sx is in the charge state or the discharge standby state such that a ratio of a sum value of the charge power limit values of the electricity storage strings S1 to Sx in the charge state to a sum value of the discharge power limit values of the electricity storage strings S1 to Sx in the discharge standby state approaches the charge/discharge standby ratio as much as possible.

Here, during charge when the charge and discharge mode is executed, the load consumption power P_{Z} may exceed the solar generation power P_{PV}. In this case, the electricity storage system controller 100 increases the electricity storage system power P_{BAT} of the electricity storage strings S1 to Sx in the charge state from a negative value to 0, and increases the electricity storage system power P_{BAT} of the electricity storage strings S1 to Sx in the discharge standby state from 0 to a positive value. It is not essential to maintain the electricity storage system power P_{BAT} of the electricity storage strings S1 to Sx in the discharge standby state at 0 during charge when the charge and discharge mode is executed. During charge when the charge and discharge mode is executed, the electricity storage system power P_{BAT} of the electricity storage strings S1 to Sx in the discharge standby state may be a negative value to charge the electricity storage strings S1 to Sx in the discharge standby state.

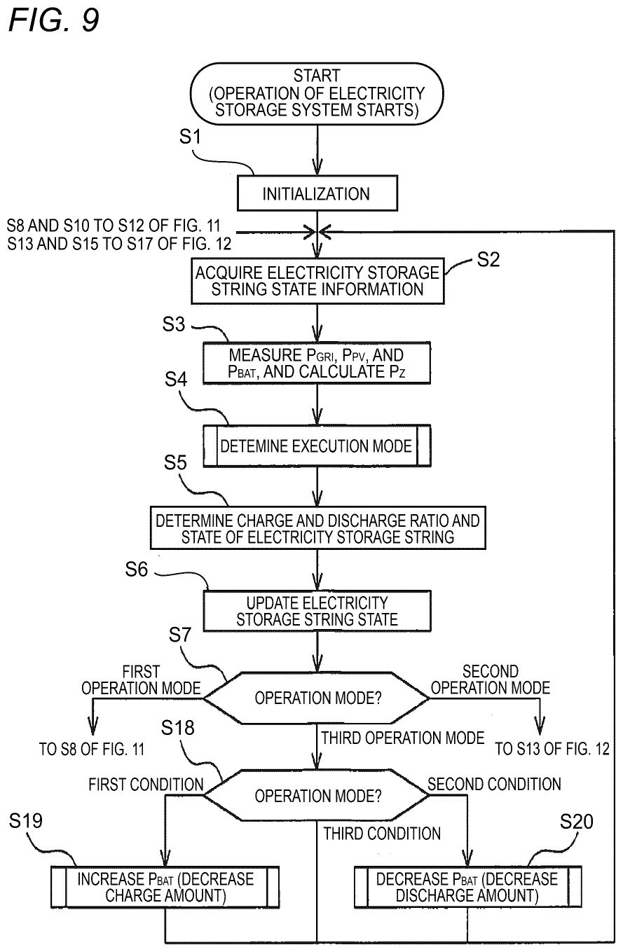

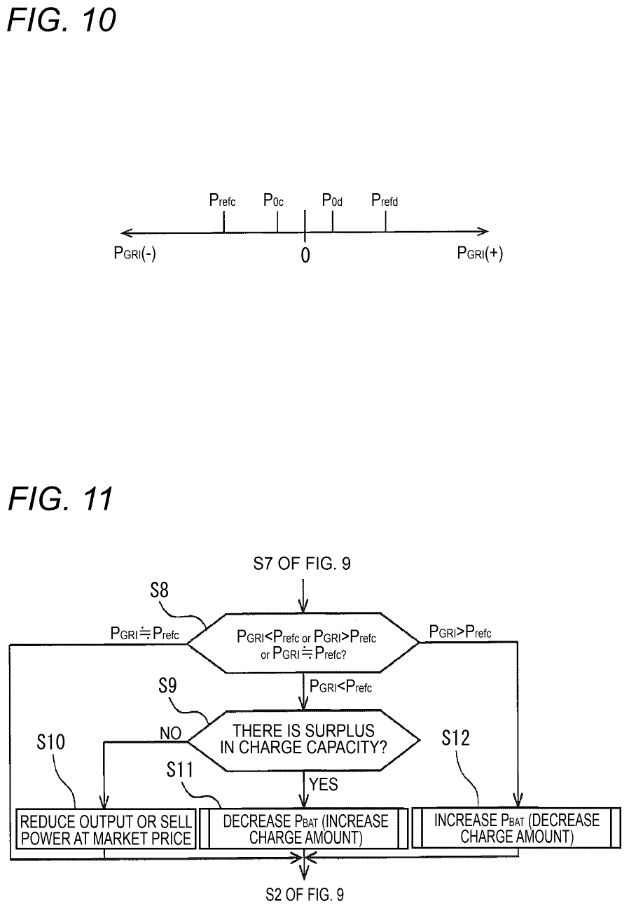

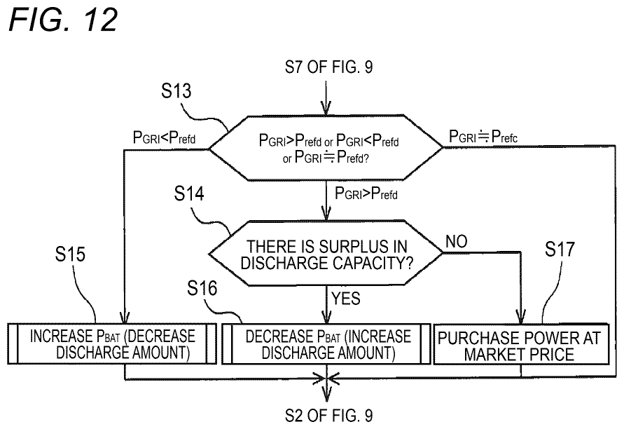

FIGS. 9, 11, and 12 are flowcharts illustrating processing of the electricity storage system controller 100. First, as illustrated in FIG. 9, when an operation of the electricity storage system 1 is started, the electricity storage system controller 100 initializes parameters such as the charge power limit value, the discharge power limit value, the SOC and the SOH of the storage battery module M, constants used in arithmetic processing, and the like (step S1). Next, the electricity storage system controller 100 acquires information on the state of each of the electricity storage strings S1 to Sx, such as the charge power limit value, and the discharge power limit value, and the SOC and SOH of each of the storage battery modules M, and the like from each of the string controllers C1 to Cx (step S2).

Next, the electricity storage system controller 100 acquires the purchased power P_{GRI} or the sold power (−P_{GRI}) measured by the power meter W_{GRI}, the solar generation power P_{PV} measured by the power meter W_{PV}, and the sum value (the electricity storage system power P_{BAT}) of the charge and discharge power of the electricity storage strings S1 to Sx measured by the power meters W₁ to W_{X}, and calculates the load consumption power P_{Z} represented by the above formula (3) (step S3). It is not essential to measure the charge and discharge power of the electricity storage strings S1 to Sx by the power meter W₁ to W_{X}, and the electricity storage system power P_{BAT} may be calculated using an instruction value (a control amount) of the charge and discharge power output by the electricity storage system controller 100.

Next, the electricity storage system controller 100 determines an execution mode of the electricity storage system 1 to be any one of the discharge mode, the charge mode, and the charge and discharge mode according to the magnitude relationship between the solar generation power P_{PV} and the load consumption power P_{Z} (step S4). The magnitude relationship between the solar generation power P_{PV} and the load consumption power P_{Z} may be a comparison between the solar generation power P_{PV} acquired in step S3 and the load consumption power P_{Z}, or may be a comparison between the moving average value of the latest solar generation power P_{PV} and the moving average value of the latest load consumption power P_{Z}. The magnitude relationship between the solar generation power P_{PV} and the load consumption power P_{Z} may be obtained from a comparison between the solar generation power P_{PV} and the load consumption power P_{Z} predicted based on the weather forecast.

In step S4, the electricity storage system controller 100 determines the discharge mode when the solar generation power P_{PV} falls below the load consumption power P_{Z} and the difference (P_{Z}−P_{PV}) therebetween is equal to or larger than a predetermined value P′. When the solar generation power P_{PV} exceeds the load consumption power P_{Z} and the difference (P_{PV}−P_{Z}) therebetween is equal to or larger than the predetermined value P′, the electricity storage system controller 100 determines the charge mode. When the difference between the solar generation power P_{PV} and the load consumption power P_{Z} is less than the predetermined value P′, the electricity storage system controller 100 determines the charge and discharge mode.

Next, the electricity storage system controller 100 determines, according to the execution mode determined in step S4, a ratio (hereinafter referred to as a charge and discharge ratio) of the electricity storage strings S1 to Sx in the charge state or the charge standby state to the electricity storage strings S1 to Sx in the discharge standby state or the discharge state (step S5). When the execution mode is determined to be the charge and discharge mode in step S4, the electricity storage system controller 100 determines the state (the discharge state or the charge standby state, or the charge state or the discharge standby state) of each of the electricity storage strings S1 to Sx (step S5).

In step S5, the electricity storage system controller 100 sets the charge and discharge ratio (charge:discharge) in the discharge mode to 0:x, sets the charge and discharge ratio in the charge mode to x:0, and sets the charge and discharge ratio in the charge and discharge mode to n:m (n and m are integers, and n+m=x).

In step S5, at the time of the transition from the discharge mode to the charge and discharge mode, the electricity storage system controller 100 determines the charge and discharge ratio n:m according to the magnitude relationship between the predicted solar generation power P_{PV} and the predicted load consumption power P_{Z} included in the transition prediction information. For example, the less the average value of the predicted solar generation power P_{PV} is relative to the average value of the predicted load consumption power P_{Z}, the larger the charge and discharge ratio n:m is determined such that a proportion (m/(n+m) occupied by the electricity storage strings S1 to Sx in the discharge state becomes.

In contrast, in step S5, at a time of a transition from the charge mode to the charge and discharge mode, the electricity storage system controller 100 determines the charge and discharge ratio n:m according to the magnitude relationship between the predicted solar generation power P_{PV} and the predicted load consumption power P_{Z} included in the transition prediction information. For example, the larger the average value of the predicted solar generation power P_{PV} is relative to the average value of the predicted load consumption power P_{Z}, the larger the charge and discharge ratio is determined such that a proportion (n/(n+m)) occupied by the electricity storage strings S1 to Sx in the charge state becomes.

In step S5, at the time of the transition from the discharge mode to the charge and discharge mode, the electricity storage system controller 100 determines whether the electricity storage strings S1 to Sx is in the discharge state or the charge standby state such that the ratio of the sum value of the discharge power limit values of the electricity storage strings S1 to Sx in the discharge state to the sum value of the charge power limit values of the electricity storage strings S1 to Sx in the charge standby state approaches the charge and discharge ratio as much as possible.

In contrast, in step S5, at the time of the transition from the charge mode to the charge and discharge mode, the electricity storage system controller 100 determines whether the electricity storage strings S1 to Sx is in the charge state or the discharge standby state such that the ratio of the sum value of the charge power limit values of the electricity storage strings S1 to Sx in the charge state to the sum value of the discharge power limit values of the electricity storage strings S1 to Sx in the discharge standby state approaches the charge and discharge ratio as much as possible.

Next, the electricity storage system controller 100 controls the power converters PCS1 to PCSx to be updated to the charge and discharge ratio and the state of the electricity storage strings S1 to Sx, which are determined in step S5 (step S6).

Next, the electricity storage system controller 100 determines which execution condition of a first operation mode, a second operation mode, and a third operation mode is satisfied (step S7). The first operation mode is determined to be the charge mode or the charge and discharge mode in step S4, and the execution condition is satisfied when charge and power selling are in progress. The second operation mode is determined to be the discharge mode or the charge and discharge mode in step S4, and the execution condition is satisfied when discharge and power purchasing are in progress. In the third operation mode, the execution condition is satisfied when the execution conditions of the first operation mode and the second operation mode are not satisfied.

In step S7, the electricity storage system controller 100 determines whether the electricity storage system 1 is being charged or discharged based on the electricity storage system power P_{BAT}. Specifically, the electricity storage system controller 100 determines that the electricity storage system 1 is discharging when the electricity storage system power P_{BAT}, which is the sum value of the power measured by the power meters W₁ to W_{X}, is a positive value. In contrast, the electricity storage system controller 100 determines that the electricity storage system 1 is being charged when the electricity storage system power P_{BAT} is a negative value.

The electricity storage system controller 100 determines whether power is being purchased from the system or is being sold to the system based on purchased power P_{GRI}. Hereinafter, a method of determining whether power is being purchased or sold will be described with reference to FIG. 10.

FIG. 10 is a diagram illustrating a threshold when the electricity storage system controller 100 determines whether power is being purchased or sold, and a reference level when the electricity storage system controller 100 controls the purchased power P_{GRI} and the sold power (−P_{GRI}). As illustrated in this figure, when the purchased power P_{GRI} is a positive value, the power is being purchased, and when the purchased power P_{GRI} is a negative value, the power is being sold. Here, a threshold (hereinafter, referred to as a power purchasing threshold) P_{0d} for determining that power is being purchased is set to a value slightly shifted in a positive direction from P_{GRI}=0 to remove the influence of noise. Similarly, a threshold (hereinafter, referred to as a power selling threshold) P_{0c} for determining that power is being sold is set to a value slightly shifted in a negative direction from P_{GRI}=0 to remove the influence of noise. Here, when the execution condition of the third operation mode is satisfied, the purchased power P_{GRI} is a value larger than the power selling threshold P_{0c} and less than the power purchasing threshold Pod. Reference levels P_{refc} and P_{refd} illustrated in FIG. 10 will be described later.

As illustrated in FIG. 9, if it is determined in step S7 that the execution condition of the first operation mode is satisfied, the processing proceeds to step S8 in FIG. 11, and if it is determined in step S7 that the execution condition of the second operation mode is satisfied, the processing proceeds to step S13 in FIG. 12. If it is determined in step S7 that the execution condition of the third operation mode is satisfied, the processing proceeds to step S18.

When the execution condition of the first operation mode is satisfied, the electricity storage system controller 100 determines whether the purchased power P_{GRI} is less than the reference level P_{refc}, the purchased power P_{GRI} is larger than the reference level P_{refc}, or the purchased power P_{GRI} is equal to the reference level P_{refc} (step S8 in FIG. 11). If it is determined in step S8 that the purchased power P_{GRI} is less than the reference level P_{refc}, the processing proceeds to step S9, and if it is determined in step S8 that the purchased power P_{GRI} is larger than the reference level P_{refc}, the processing proceeds to step S12. If it is determined in step S8 that the purchased power P_{GRI} is equal to the reference level P_{refc} (a difference between the purchased power P_{GRI} and the reference level P_{refc} is equal to or less than a threshold), the processing proceeds to step S2 in FIG. 9.

In contrast, when the execution condition of the second operation mode is satisfied, the electricity storage system controller 100 determines whether purchased power P_{GRI} is larger than the reference level P_{refd}, the purchased power P_{GRI} is less than the reference level P_{refd}, or the purchased power P_{GRI} is equal to the reference level P_{refd} (step S13 in FIG. 12). If it is determined in step S13 that the purchased power P_{GRI} is larger than the reference level P_{refd}, the processing proceeds to step S14, and if it is determined in step S13 that the purchased power P_{GRI} is less than the reference level P_{refd}, the processing proceeds to step S15. If it is determined in step S13 that the purchased power P_{GRI} is equal to the reference level P_{refd} (a difference between the purchased power P_{GRI} and the reference level P_{refd} is equal to or less than a threshold), the processing proceeds to step S2 in FIG. 9.

As illustrated in FIG. 10, the reference level P_{refc} is a negative value, and is a value less than the power selling threshold Poe. From a viewpoint of reducing a power selling amount, it is desirable that a difference between the reference level P_{refc} and the power selling threshold P_{0c} is as small as possible. The reference level P_{refd} is a positive value, and is a value larger than the power purchasing threshold Pod. From a viewpoint of reducing a power purchasing amount, it is desirable that a difference between the reference level P_{refd} and the power purchasing threshold Pod is as small as possible.

As illustrated in FIG. 11, if the purchased power P_{GRI} is less than the reference level P_{refc}, the electricity storage system controller 100 determines whether there is a surplus in the charge capacity of the electricity storage system 1 (step S9). In step S9, if it is determined that there is a surplus in the charge capacity of the electricity storage system 1, the processing proceeds to step 11, and in step S9, if it is determined that there is no surplus in the charge capacity of the electricity storage system 1, the processing proceeds to step 10.

When there is no surplus in the charge capacity of the electricity storage system 1, the electricity storage system controller 100 decreases the solar generation power P_{PV} by one step with a predetermined control amount (step S10: output reduction). Accordingly, the purchased power P_{GRI} approaches the reference level P_{refc}, and the power selling amount is reduced. In step S10, power may be sold at a market price as an emergency measure.

On the other hand, if there is a surplus in the charge capacity of the electricity storage system 1, the electricity storage system controller 100 decreases the electricity storage system power P_{BAT} by one step with a predetermined control amount (step S11: increase charge amount). Accordingly, the purchased power P_{GRI} approaches the reference level P_{refc}, and the power selling amount is reduced.

If the purchased power P_{GRI} is larger than the reference level P_{refc}, the electricity storage system controller 100 increases the electricity storage system power P_{BAT} by one step with a predetermined control amount (step S12: decrease charge amount). Accordingly, the purchased power P_{GRI} approaches the reference level P_{refc}.

As illustrated in FIG. 12, if the purchased power P_{GRI} is less than the reference level P_{refd}, the electricity storage system controller 100 decreases the electricity storage system power P_{BAT} by one step with a predetermined control amount (step S15: decrease discharge amount). Accordingly, the purchased power P_{GRI} approaches the reference level P_{refd}.

On the other hand, if the purchased power P_{GRI} is larger than the reference level P_{refd}, the electricity storage system controller 100 determines whether there is a surplus in a discharge capacity of the electricity storage system 1 (step S14). If it is determined in step S14 that there is a surplus in the discharge capacity of the electricity storage system 1, the processing proceeds to step 16, and if it is determined in step S14 that there is no surplus in the discharge capacity of the electricity storage system 1, the processing proceeds to step 17.

When there is no surplus in the discharge capacity of the electricity storage system 1, the electricity storage system controller 100 performs power purchase at a market price as an emergency measure. (step S17). On the other hand, if there is a surplus in the discharge capacity of the electricity storage system 1, the electricity storage system controller 100 increases the electricity storage system power P_{BAT} by one step with a predetermined control amount (step S16: increase discharge amount). Accordingly, the purchased power P_{GRI} approaches the reference level P_{refd}, and the power purchasing amount is reduced.

As illustrated in FIG. 9, if the execution condition of the third operation mode is satisfied, the electricity storage system controller 100 determines which of a first condition, a second condition, and a third condition is satisfied (step S18). The first condition is a condition that the electricity storage system power P_{BAT} is less than 0 (during charge) and the purchased power P_{GRI} is equal to or larger than the power purchasing threshold Pod (during power purchasing). The second condition is a condition that the electricity storage system power P_{BAT} is equal to or larger than 0 (during discharge) and the purchased power P_{GRI} is equal to or less than the power selling threshold P_{0c} (during power selling). The third condition is a condition that the purchased power P_{GRI} is larger than the power selling threshold P_{0c} and less than the power purchasing threshold Pod.

If it is determined in step S18 that the first condition is satisfied, the processing proceeds to step S19, and if it is determined in step S18 that the second condition is satisfied, the processing proceeds to step S20. Here, when the first condition or the second condition is satisfied in step S18, an irregular state occurs in the charge and discharge and trading power of the electricity storage system 1. Therefore, in step S19 and S20 to be described later, the electricity storage system controller 100 executes processing of stabilizing the charge and discharge state of the electricity storage system 1 and the power trading state.

On the other hand, if it is determined in step S18 that the third condition is satisfied, the processing proceeds to step S2. In this case, since the charge and discharge state of the electricity storage system 1 and the power trading state are stable, processing such as step S19 and S20 to be described later is unnecessary.

If it is determined in step S18 that the first condition is satisfied, the electricity storage system controller 100 increases the electricity storage system power P_{BAT} by one step with a predetermined control amount (step S19: decrease charge amount). Accordingly, charge of the electricity storage system 1 by power purchase is reduced. The processing proceeds from step S19 to step S2.

If it is determined that the second condition is satisfied in step S18, the electricity storage system controller 100 decreases the electricity storage system power P_{BAT} by one step with a predetermined control amount (step S20: decrease discharge amount). Accordingly, power selling by discharge of the electricity storage system 1 is reduced. The processing proceeds from step S20 to step S2.

As described above, the electricity storage system controller 100 according to the present embodiment executes the charge and discharge mode in which a part of the plurality of electricity storage strings S1 to Sx is in the discharge state and the electricity storage strings S1 to Sx other than the part are in the charge standby state, or a part of the plurality of electricity storage strings S1 to Sx are in the charge state and the electricity storage strings S1 to Sx other than the part are in the discharge standby state. Accordingly, switching between charge and discharge of the electricity storage system 1 can be smoothly performed.

Here, the electricity storage system controller 100 determines the charge and discharge ratio based on the transition prediction information in which the transitions of the solar generation power P_{PV} and the load consumption power P_{Z} are predicted. As described above, the charge and discharge ratio is a ratio of the electricity storage strings S1 to Sx in the discharge state to the electricity storage strings S1 to Sx in the charge standby state, or a ratio of the electricity storage strings S1 to Sx in the charge state to the electricity storage strings S1 to Sx in the discharge standby state. Accordingly, it is possible to optimize the discharge power (+P_{BAT}) and the charge power (−P_{BAT}) of the electricity storage system 1 according to the balance between the solar generation power P_{PV} and the load consumption power P_{Z}. For example, in a time zone in which the charge and discharge mode is executed, when the difference (P_{Z}−P_{PV}) when the solar generation power P_{PV} falls below the load consumption power P_{Z} is larger than the difference (P_{PV}−P_{Z}) when the solar generation power P_{PV} exceeds the load consumption power P_{Z}, the proportion occupied by the electricity storage strings S1 to Sx in the discharge state or the discharge standby state can be increased. On the other hand, in the time zone in which the charge and discharge mode is executed, when the difference (P_{PV}−P_{Z}) when the solar generation power P_{PV} exceeds the load consumption power P_{Z} is larger than the difference (P_{Z}−P_{PV}) when the solar generation power P_{PV} falls below the load consumption power P_{Z}, the proportion occupied by the electricity storage strings S1 to Sx in the charge state or the charge standby state can be increased. Therefore, it is possible to prevent occurrence of excess or deficiency in the discharge power (+P_{BAT}) and the charge power (−P_{BAT}) of the electricity storage system 1. Therefore, power purchasing can be reduced by covering a shortage of the solar generation power P_{PV} by discharging the electricity storage system 1, and power selling can be reduced by storing the surplus of the solar generation power P_{PV} by charging the electricity storage system 1.

The electricity storage system controller 100 determines the charge and discharge ratio according to a ratio of the discharge power (+P_{BAT}) to the charge power (−P_{BAT}) of the electricity storage system 1 predicted based on the transitions of the solar generation power P_{PV} and the load consumption power P_{Z}. Accordingly, for example, in the time zone in which the charge and discharge mode is executed, the larger the difference is when the predicted discharge power (+P_{BAT}) exceeds the predicted charge power (−P_{BAT}) is, the larger the proportion occupied by the electricity storage strings S1 to Sx in the discharge state or the discharge standby state becomes. On the other hand, in the time zone in which the charge and discharge mode is executed, the larger the difference is when the charge power (−P_{BAT}) exceeds the discharge power (+P_{BAT}), the larger the proportion occupied by the electricity storage strings S1 to Sx in the charge state or the charge standby state becomes.

The electricity storage system controller 100 determines whether each of the electricity storage strings S1 to Sx is in the discharge state or the charge standby state, according to the ratio of the sum value of the discharge power limit values of the electricity storage strings S1 to Sx in the discharge state to the sum value of the charge power limit values of the electricity storage strings S1 to Sx in the charge standby state. Alternatively, the electricity storage system controller 100 determines whether each of the electricity storage strings S1 to Sx is in the charge state or the discharge standby state, according to the ratio of the sum value of the charge power limit values of the electricity storage strings S1 to Sx in the charge state to the sum value of the discharge power limit values of the electricity storage strings S1 to Sx in the discharge standby state.

Accordingly, for example, the ratio of the sum value of the discharge power limit values of the electricity storage strings S1 to Sx in the discharge state to the sum value of the charge power limit values of the electricity storage strings S1 to Sx in the charge standby state can be brought close to the charge and discharge ratio. The ratio of the sum value of the charge power limit values of the electricity storage strings S1 to Sx in the charge state to the sum value of the discharge power limit values of the electricity storage strings S1 to Sx in the discharge standby state can be brought close to the charge and discharge ratio. Therefore, the charge and discharge ratio can be optimized according to the charge and discharge power limit value.

At the time of discharge of the electricity storage system 1, when an absolute value of the purchased power (+P_{GRI}) from the power grid is equal to or larger than the power purchasing threshold Pod, the electricity storage system controller 100 adjusts the discharge power (+P_{BAT}) of the electricity storage system 1 such that the absolute value of the purchased power (+P_{GRI}) approaches the reference level P_{refd} having an absolute value larger than the power purchasing threshold Pod. Accordingly, the purchased power (+P_{GRI}) can be stabilized to a value close to the reference level P_{refd}.

At the time of charge of the electricity storage system 1, when the absolute value of the sold power (−P_{GRI}) to the power grid is equal to or larger than the power selling threshold P_{0c}, the electricity storage system controller 100 adjusts the charge power (−P_{BAT}) of the electricity storage system 1 such that the absolute value of the sold power (−P_{GRI}) approaches the reference level P_{refc} having an absolute value larger than the power selling threshold P_{0c}. Accordingly, the sold power (−P_{GRI}) can be stabilized to a value close to the reference level P_{refc}.

Although the present invention has been described above based on the above embodiment, the present invention is not limited to the above embodiment, and modifications may be made without departing from the gist of the present invention, and publicly known or well-known techniques may be appropriately combined.

For example, in the above embodiment, the electricity storage system controller 100 executes the discharge mode in which all the electricity storage strings S1 to Sx are in the discharge state and the charge mode in which all the electricity storage strings S1 to Sx are in the charge state. However, execution of the discharge mode and the charge mode is not essential, and the charge and discharge mode may be always executed.

In the above embodiment, the electricity storage system controller 100 predicts the necessary discharge power (+P_{BAT}) and charge power (−P_{BAT}) of the electricity storage system 1 based on the transition prediction information in which the transitions of the solar generation power P_{PV} and the load consumption power P_{Z} are predicted. Then, the electricity storage system controller 100 determines the charge and discharge ratio based on the predicted discharge power (+P_{BAT}) and the predicted charge power (−P_{BAT}). However, the electricity storage system controller 100 may acquire the transition prediction information on the discharge power (+P_{BAT}) and the charge power (−P_{BAT}) of the electricity storage system 1 predicted based on the time zone, weather, season, and the like from the host system, and determine the charge and discharge ratio based on the acquired transition prediction information.

In the above embodiment, when discharge progresses during discharge in the charge and discharge mode, the discharge capacity of the electricity storage strings S1 to Sx in the discharge state decreases. Therefore, before and after the discharge capacity of the electricity storage strings S1 to Sx disappears, the electricity storage strings S1 to Sx in the discharge state and the electricity storage strings S1 to Sx in the charge standby state may be exchanged. At this time, the charge and discharge ratio may be updated according to the latest operation state.

In the above embodiment, when charge proceeds during charge in the charge and discharge mode, the charge capacity of the electricity storage strings S1 to Sx in the charge state decreases. Therefore, before and after the charge capacity of the electricity storage strings S1 to Sx disappears, the electricity storage strings S1 to Sx in the charge state and the electricity storage strings S1 to Sx in the discharge standby state may be exchanged. At this time, the charge and discharge ratio may be updated according to the latest operation state.

In the above embodiment, charge of the electricity storage system 1 by power purchasing and power selling by discharging the electricity storage system 1 are not performed, but may be performed as necessary. In the above embodiment, each of the plurality of storage batteries connected in parallel to the power reception point is the electricity storage strings S1 to Sx. However, it is not essential to configure each storage battery by the electricity storage strings S1 to Sx, and each storage battery may be configured by one electricity storage string. In the above embodiment, the power generation device is the solar power generation device 5, but the power generation device may be any device whose generated power fluctuates depending on the environment, such as a wind power generation device or a tidal power generation device.

### Reference Example

In a reference example, a charge and discharge ratio during execution of a charge and discharge mode is constant, and the electricity storage system controller 100 does not determine the charge and discharge ratio. In contrast, in the reference example, the electricity storage system controller 100 executes the processing of steps S1 to S4 and S6 to S20 illustrated in FIGS. 9, 11, and 12 to reduce power purchasing and power selling.

Although various embodiments have been described above, it is needless to say that the present invention is not limited to these examples. It is apparent that those skilled in the art can come up with various modifications or corrections within the scope of the claims, and it is understood that the modifications or corrections naturally fall within the technical scope of the present invention. In addition, components described in the above embodiments may be combined freely without departing from the spirit of the invention.

The present application is based on a Japanese patent application (No. 2023-105014) filed on Jun. 27, 2023, the contents of which are incorporated herein by reference.

### REFERENCE SIGNS LIST

1: electricity storage system
4: load
5: solar power generation device (power generation device)
10: PV-electricity storage system (power system)
100: electricity storage system controller (storage battery control device)
PCS1 to PCSx: power converter
P_{0c}: power selling threshold (second threshold)
P_{0d}: power purchasing threshold (first threshold)
P_{BAT}: electricity storage system power (discharge power, charge power)
P_{GRI}: purchased power (sold power)
P_{PV}: solar generation power (generated power)
P_{refc}: reference level (second reference level)
P_{refd}: reference level (first reference level)
P_{Z}: load consumption power (consumption power of load)
S1 to Sx: electricity storage string (storage battery)

What is claimed is:

1. An storage battery control device for controlling charge and discharge of an electricity storage system in a power system,
the power system including
the electricity storage system that includes a plurality of bidirectional power converters connected in parallel to a power reception point of a power grid and a plurality of storage batteries connected to the power converters, respectively, and
a power generation device connected to the power reception point, wherein
the storage battery control device
executes charge and discharge mode in which a part of the plurality of storage batteries are in a discharge state and the storage batteries other than the part are in a charge standby state, or a part of the plurality of storage batteries are in a charge state and the storage batteries other than the part are in a discharge standby state, and
determines a ratio of the storage batteries in the discharge state to the storage batteries in the charge standby state, or a ratio of the storage batteries in the charge state to the storage batteries in the discharge standby state, based on transition prediction information in which transitions of generated power of the power generation device and consumption power of a load connected to the power reception point, or transitions of discharge power and charge power of the electricity storage system are predicted.

2. The storage battery control device according to claim 1, wherein
the ratio of the storage batteries in the discharge state to the storage batteries in the charge standby state, or the ratio of the storage batteries in the charge state to the storage batteries in the discharge standby state, is determined based on a ratio of the predicted discharge power to the predicted charge power of the electricity storage system included in the transition prediction information.

3. The storage battery control device according to claim 2, wherein
whether each of the plurality of storage batteries is determined to be in the discharge state or the charge standby state according to a ratio of a sum value of discharge power limit values of the storage batteries in the discharge state to a sum value of charge power limit values of the storage batteries in the charge standby state, or
whether each of the plurality of storage batteries is determined to be in the charge state or the discharge standby state according to a ratio of a sum value of charge power limit values of the storage batteries in the charge state to a sum value of discharge power limit values of the storage batteries in the discharge standby state.

4. The storage battery control device according to claim 1, wherein
at a time of discharge of the electricity storage system, when an absolute value of purchased power from the power grid is equal to or larger than a first threshold, the discharge power of the electricity storage system is adjusted such that the absolute value of purchased power approaches a first reference level having an absolute value larger than the first threshold.

5. The storage battery control device according to claim 1, wherein
at a time of charge of the electricity storage system, when an absolute value of sold power from to the power grid is equal to or larger than a second threshold, the charge power of the electricity storage system is adjusted such that the absolute value of sold power approaches a second reference level having an absolute value larger than the second threshold.

6. An electricity storage system provided in a power system in which a power generation device is connected to a power reception point of a power grid, the electricity storage system comprising:
a plurality of bidirectional power converters connected in parallel to the power reception point;
a plurality of storage batteries connected to the power converters, respectively; and
an storage battery control device configured to control charge and discharge of the plurality of storage batteries, wherein
the storage battery control device
executes a charge and discharge mode in which a part of the plurality of storage batteries are in a discharge state and the storage batteries other than this part are in a charge standby state, or a part of the plurality of storage batteries are in a charge state and the storage batteries other than this part are in a discharge standby state, and
determines a ratio of the storage batteries in the discharge state to the storage batteries in the charge standby state, or a ratio of the storage batteries in the charge state to the storage batteries in the discharge standby state, based on transition prediction information in which transitions of generated power of the power generation device and consumption power of a load connected to the power reception point, or transitions of discharge power and charge power of the electricity storage system are predicted.

7. An storage battery control method executed by using a storage battery control device configured to control charge and discharge of an electricity storage system in a power system,
the power system including
the electricity storage system that includes a plurality of bidirectional power converters connected in parallel to a power reception point of a power grid and a plurality of storage batteries connected to the power converters, respectively, and
a power generation device connected to the power reception point,
the storage battery control method comprising:
executing a charge and discharge mode in which a part of the plurality of storage batteries are in a discharge state and the storage batteries other than this part are in a charge standby state, or a part of the plurality of storage batteries are in a charge state and the storage batteries other than this part are in a discharge standby state, and
determining a ratio of the storage batteries in the discharge state to the storage batteries in the charge standby state, or a ratio of the storage batteries in the charge state to the storage batteries in the discharge standby state, based on transition prediction information in which transitions of generated power of the power generation device and consumption power of a load connected to the power reception point, or transitions of discharge power and charge power of the electricity storage system are predicted.
